(19) United States
(12) Patent Application Publication
(10) Pub. No.: US 2023/0307222 A1
(43) Pub. Date: Sep. 28, 2023

(54) ION SOURCE AND MASS SPECTROMETER

(71) Applicant: Shimadzu Corporation, Kyoto (JP)

(72) Inventors: Saifei CHEN, Shanghai (CN); Yiming WANG, Shanghai (CN); Yiming LIN, Shanghai (CN); Wenjian SUN, Shanghai (CN)

(21) Appl. No.: 18/127,113

(22) Filed: Mar. 28, 2023

(30) Foreign Application Priority Data
Mar. 28, 2022 (CN) 202210316896.9

(51) Int. Cl. H01J 49/10

(52) U.S. Cl. CPC H01J 49/10

(57) ABSTRACT

The present invention relates to the technical field of analytical instruments, in particular to an ion source and a mass spectrometer. The ion source includes dielectric barrier discharge assemblies, wherein the dielectric barrier discharge assembly is composed of a first electrode plate, a dielectric spacer plate and a second electrode plate which are in close proximity in parallel in sequence, and a first through hole penetrating through the first electrode plate, a second through hole penetrating through the dielectric spacer plate and a third through hole penetrating through the second electrode plate are disposed corresponding to each other to form a gas passageway for gas to be ionized. The ion source of the present invention is simple in structure, compact, small in size, and extremely low in energy consumption, and is particularly suitable for use on miniaturized hand-held instruments.

### CROSS-REFERENCE TO RELATED PATENT APPLICATION

This application claims priority to and the benefit of Chinese Patent Application Serial No. 202210316896.9, filed Mar. 28, 2022, which is incorporated herein in its entirety by reference.

### TECHNICAL FIELD

The present invention relates to the technical field of analytical instruments, in particular to an ion source and a mass spectrometer.

### BACKGROUND

Dielectric Barrier Discharge (DBD) is a uniform, dispersed and stable discharge phenomenon. When a high voltage and high frequency alternating current is applied to a pair of electrodes separated by an insulating dielectric, the phenomenon of continuous and rapid pulse discharge will occur around the insulating dielectric due to the existence of the insulating dielectric, which will appear as a dispersed, uniform and stable plasma region on the macro level. When gaseous substances flow through this region, ions will be formed due to discharge or charge transfer, so more and more researchers have noticed that ion sources for analytical instruments can be manufactured by this phenomenon.

At present, among the widely used ion sources, electrospray ionization (ESI) requires the use of spray formed by solvent to ionize samples, and atmospheric pressure chemical ionization (APCI) sources require carrier gas to assist ionization, resulting in a complex structure of the ion source. Electron ionization (EI) sources require high vacuum, and their application environment is relatively harsh, which then results in a complex structure of the ion source and large space occupation; it is needed to additionally configure matrix and high-performance lasers for matrix assisted laser desorption ionization (MALDI), and consequently the price is high; it is often needed to design a special ionization chamber for vacuum ultra-violet (VUV) sources used by PI sources, and a large space is occupied when the PI source is used. DBD ionization sources have many advantages, such as small size, compact structure, stable discharge, wide application of samples, etc.

DBD devices commonly used as ionization sources in the prior art include devices in an axis type, an internal and external double-ring type and an external double-ring type.

Patent document US2013/0161507A1 discloses a mass spectrometer with a dielectric barrier discharge structure as an ion source. The gas pressure in the discharge region is 2 torr to 300 torr. Gaseous substances generated due to volatilization of samples to be analyzed in the sample container enter an ionization region under the effect of a negative pressure. Furthermore, the ionized sample enters the mass spectrometer for detection. The application of this device is limited to the analysis of specific volatile substances. Its ionization structure requires a relatively low gas pressure and cannot work at atmospheric pressure, which further restricts its application.

Patent document CN108701578B discloses an ionization device based on dielectric barrier discharge. Electrodes are located on the inner side and the outer side of the hollow structure composed of dielectric elements. The sample is ionized as it flows through the hollow structure. The gas pressure in the ionization region is above 60 KPa, preferably the ionization region may work at atmospheric pressure. The structure of the device requires high assembly accuracy, leading to machining and manufacturing difficulties; a large percentage of dielectric material is exposed in the sample transition path, leading to accumulation of charges on the surface of the dielectric element, which in turn affects the ionization effect of the carrier gas or sample; it also requires occupying a relatively large axial space, leading to a structure that is too thick in front of the mass spectrometry interface, which limits the development of miniaturization of mass spectrometers; in addition, the sample directly passes through the plasma region and makes contact with high voltage electrode, which may generate more fragment ions during ionization.

Patent document WO2009102766 introduces an ionization probe based on dielectric barrier discharge. Carrier gas (such as helium, nitrogen, etc.) is ejected out of the probe after passing through the DBD ionization region to form a low temperature plasma wake flame containing a large number of charged particles, and the wake flame and substances to be detected are ionized by mechanisms such as charge transfer. This scheme has high flexibility and practicability, but is limited by the efficiency of charge transfer and the mutual exclusion of charged particles, which will cause considerable ion losses, so the sensitivity of subsequent analysis will be lowered. In addition, it is difficult for the electrode configuration in the axis type to ensure the parallelism, which may cause partial discharge concentration, unstable discharge position and other problems, thus affecting the stability of ion flow.

Patent document CN102522310A introduces a device in which multiple groups of annular dielectric barrier discharges are cascaded. The plasma excited by multiple groups of annular discharge electrodes leaves the ionization chamber under the action of repulsion electrodes. Positive and negative ions can be selectively ejected by changing the positive and negative voltages of the repulsion electrodes, which has high flexibility. However, the parallelism between the annular discharge electrodes outside the insulating dielectric chamber is difficult to ensure, and the discharge region may be concentrated on one side. In addition, it must also be ensured that there is no gap between the electrode and the insulating dielectric, otherwise the discharge may occur outside the insulating dielectric chamber.

In view of the above problems in the prior art, a dielectric barrier discharge ion source capable of being applied to miniaturized (or compact) mass spectrometers is urgently needed in the field of mass spectrometry, and can meet the gas pressure requirements of miniaturized ion sources working at a low gas pressure or an atmospheric pressure, and has the advantages of high ionization efficiency and easy processing and manufacturing.

In recent years, some research groups have published research papers about the planar DBD phenomena. It has been found by research that planar DBD formed by tabulate electrodes and insulating dielectric by stacking can also maintain stable discharge. The mechanism of the planar DBD phenomenon is discussed in these research papers at a deep level, and the application of the planar DBD structure in spectral analysis is found.

Specifically, Kim et al. disclosed a planar DBD structure of a sandwich structure in Applied Sciences, 8 (8), 1294. The planar DBD structure of the sandwich structure includes a circular ring-shaped geographic pole plate, a circular dielectric plate, and a high-voltage electrode whose outer diameter matches the inner diameter of the geographic pole plate. The discharge region is located at the inner edge of the circular ring-shaped geographic pole plate. The discharge mechanism and characteristics of this planar DBD structure are studied in this paper.

R. Heming et al. disclosed a micron-sized DBD device with a through hole in the center in the literature published in “Analytical & Bioanalytical Chemistry, 2009, 395 (5), 611”, and used the device as the spectral signal source of an atomic emission spectrum. The DBD device is used for providing an optical signal of an ion torch formed by gas ionization, and optical fibers are set to collect optical signals. In this document, the DBD device is used for generating spectral signals, and ions obtained by ionization of the DBD device will not be collected. The central through hole is provided to enable the spectral signal to be received by the optical fiber on the other side. Because the central through hole is provided only to meet the need of light transmission, the size of the central through hole does not need to be large. In this document, the diameter of the central through hole is 0.1-0.3 mm, and its application in the field of mass spectrometry is limited.

### SUMMARY OF THE INVENTION

In order to solve the above-mentioned problems in the prior art, namely, how to simultaneously satisfy the requirements of a miniaturized mass spectrometer on the operating gas pressure range of an ionization source, ionization stability and the difficulty of a manufacturing process, the present invention provides an ion source, including dielectric barrier discharge assemblies, wherein the dielectric barrier discharge assembly is composed of a first electrode plate, a dielectric spacer plate and a second electrode plate which are in close proximity in parallel in sequence, and a first through hole penetrating through the first electrode plate, a second through hole penetrating through the dielectric spacer plate and a third through hole penetrating through the second electrode plate are disposed corresponding to each other to form a gas passageway for gas to be ionized.

The inventors have found that the ion source having the above structure can still achieve stable ionization at a low gas pressure or an atmospheric pressure by providing a through hole as a gas flow passageway in the center of a DBD device of a sandwich structure, because the planar DBD is formed by combining tabulate electrodes (i.e. the first electrode plate and the second electrode plate) and insulating dielectric (the dielectric spacer plate), the electrodes and the insulating dielectric can fit to each other at a high degree in case that the plate surfaces of the electrodes and the insulating dielectric are substantially flat and smooth, and it is not required to strictly control the arc surface accuracy of the electrodes and the insulating dielectric, so that the requirement for the machining accuracy is lower, and it is easier to maintain the discharge stability.

In addition, by using the central through hole of the DBD device as the gas flow passageway, it is possible to directly transport ionized ions to the other side of the DBD device along with gas glow while the gas flow is ionized. The axial direction of the DBD device is the transportation direction of the gas flow. Since the DBD device consists of multiple plate-shaped objects stacked in the axial direction, the thickness in the axial direction is only the sum of the thicknesses of the multiple plate-shaped objects, so the DBD device can be used as an ion source of a mass spectrometer, which can effectively reduce the axial length of the mass spectrometer and facilitate the miniaturization of the mass spectrometer.

In the above way, the technical solution provided by the present invention is able to take into account the requirements of miniaturized mass spectrometers on the operating gas pressure range, ionization stability and the difficulty of the manufacturing process by utilizing a simpler and more compact device.

In an optional technical solution of the present invention, the radius of the first through hole is greater than the radius of the second through hole, and the radius of the first through hole is greater than the radius of the third through hole.

In the above way, the dielectric spacer plate forms a dielectric barrier between the first electrode plate and the second electrode plate, because the radius of the first through hole is greater than the radius of the second through hole, the dielectric spacer plate can effectively form a dielectric barrier for the first electrode plate and the second electrode plate to prevent that electric arcs cross the dielectric spacer plate and then conduct the first electrode plate and the second electrode plate, thus preventing breakdown between the electrode plates. Further, as the radius of the first through hole is greater than the radius of the third through hole, by using the electrode plates with different apertures, a wider plasma discharge region can be formed between the electrode plates, which enhances the ionization stability.

In an optional technical solution of the present invention, the radius of the first through hole differs from the radius of the third through hole by 5 mm or less.

According to the technical solution, when the radius difference of the first through hole and the third through hole is within 5 mm, the requirement for the size of the plasma region generated by discharge of the first electrode plate and the second electrode plate can be satisfied, an ion source structure can also be miniaturized, the production cost is saved, and the space utilization rate within the ion source structure is improved.

In an optional technical solution of the present invention, the first through hole, the second through hole and the third through hole are disposed coaxially, the radius of the first through hole and the radius of the third through hole being the same, both being greater than the radius of the second through hole.

According to the technical solution, the radius of the first through hole and the radius of the third through hole are the same, electrode plates of the same specification and size can be used as the first electrode plate and the second electrode plate, reducing the manufacturing cost; the radii of the first through hole and the third through hole are both greater than the radius of the second through hole, making the dielectric spacer plate form a more stable dielectric barrier between the first electrode plate and the second electrode plate, and reducing the possibility of breakdown between the electrode plates.

In an optional technical solution of the present invention, the direction of the gas passageway is from the first electrode plate to the second electrode plate, or, from the second electrode plate to the first electrode plate.

In an optional technical solution of the present invention, the ion source has a plurality of dielectric barrier discharge assemblies, and gas passageways of the plurality of dielectric barrier discharge assemblies are disposed coaxially.

According to the technical solution, the path length at which gas is ionized in the dielectric barrier discharge assembly can be extended by simply stacking the plurality of dielectric barrier discharge assemblies, so that gas to be ionized can be fully ionized in a dielectric barrier discharge region, which improves the ionization effect.

In an optional technical solution of the present invention, an inter-assembly dielectric spacer plate with the insulating capacity greater than that of the dielectric spacer plate is further disposed between two adjacent dielectric barrier discharge assemblies.

According to the technical solution, the inter-assembly dielectric spacer plate is disposed to facilitate blocking the discharge of the adjacent dielectric barrier discharge assemblies, so that each dielectric barrier discharge assembly performs discharge independently, which avoids that the discharge of the adjacent dielectric barrier discharge assemblies interacts with each other and consequently the ionization effect of the gas to be ionized is affected.

In an optional technical solution of the present invention, the first electrode plate, the second electrode plate and the dielectric spacer plate are all annular.

According to the technical solution, the annular first electrode plate, the annular dielectric spacer plate and the annular second electrode plate are disposed in close proximity in parallel with each other, and central openings of the annular plates can be correspondingly communicated with each other for use as the gas passageway. The layout mode improves the compactness of the ion source structure, ensures the parallelism between the electrode plates and helps to prevent that due to structural defects, the ion source has a discharge phenomenon.

In an optional technical solution of the present invention, the dielectric spacer plate is made from ceramic, glass or quartz.

In an optional technical solution of the present invention, the operating pressure of the ion source is an atmospheric pressure, or a low gas pressure environment between 100 Pa and the atmospheric pressure.

According to the technical solution, the operating pressure of the ion source is the atmospheric pressure or a low pressure environment, which lowers the requirements for a vacuum system and facilitates the miniaturization of the ion source and a corresponding mass spectrometry system.

In an optional technical solution of the present invention, the first electrode plate is connected to an AC power supply and the second electrode plate is grounded; or, the first electrode plate is grounded and the second electrode plate is connected to an AC power supply.

In an optional technical embodiment of the present invention, the gas to be ionized is gaseous samples, gasified samples or carrier gas.

According to the technical solution, the ion source can directly ionize the gaseous sample or the gasified sample flowing through the gas passageway, or can ionize the carrier gas flowing through the gas passageway and then cause an ion torch to exchange ions with the sample so as indirectly ionize the sample.

In an optional technical solution of the present invention, the radius of the second through hole is 0.5-5 mm.

According to the technical solution, when the radius of the second through hole is less than 0.5 mm, the gas inlet volume of subsequent equipment, such as detection equipment of the mass spectrometer may be limited, and when the radius of the second through hole is greater than 5 mm, the radial distance between the dielectric barrier discharge region and the gas passageway is enlarged, resulting in the ions being unable to pass through the DBD device smoothly, which may easily lead to insufficient ionization and low ionization efficiency.

The present invention further provides a mass spectrometer applying the above-mentioned ion source.

### BRIEF DESCRIPTION OF THE DRAWINGS

FIG. 1 is a schematic cross-sectional view of a dielectric barrier discharge assembly of the first embodiment of the present invention.

FIG. 2 is a schematic cross-sectional view of a dielectric barrier discharge assembly of the second embodiment of the present invention.

FIG. 3 is a schematic cross-sectional view of a dielectric barrier discharge assembly of the third embodiment of the present invention.

FIG. 4 is a schematic cross-sectional view of a dielectric barrier discharge assembly of the fourth embodiment of the present invention.

FIG. 5 is a schematic cross-sectional view of a dielectric barrier discharge assembly of the fifth embodiment of the present invention.

FIG. 6 is a mass spectrum signal view obtained by ionizing a gasified Verapamil solution by the dielectric barrier discharge assembly of the first embodiment of the present invention.

FIG. 7 is a mass spectrum view obtained by ionizing a gasified Verapamil solution by the dielectric barrier discharge assembly of the first embodiment of the present invention.

### LIST OF REFERENCE NUMERALS

1-dielectric barrier discharge assembly; 11-first electrode plate; 111-first through hole; 12-dielectric spacer plate; 121-second through hole; 13-second electrode plate; 131-third through hole; 14-gas passageway; 2-dielectric barrier discharge region; 3-inter-assembly dielectric spacer plate.

### DETAILED DESCRIPTION

The technical solutions in embodiments of the present invention will be clearly and completely described below with reference to the accompanying drawings in the embodiments of the present invention. Apparently, the described embodiments are merely some rather than all of the embodiments of the present invention. All other embodiments obtained by a person of ordinary skill in the art based on the embodiments in the present invention without creative efforts shall fall within the protection scope of the present invention.

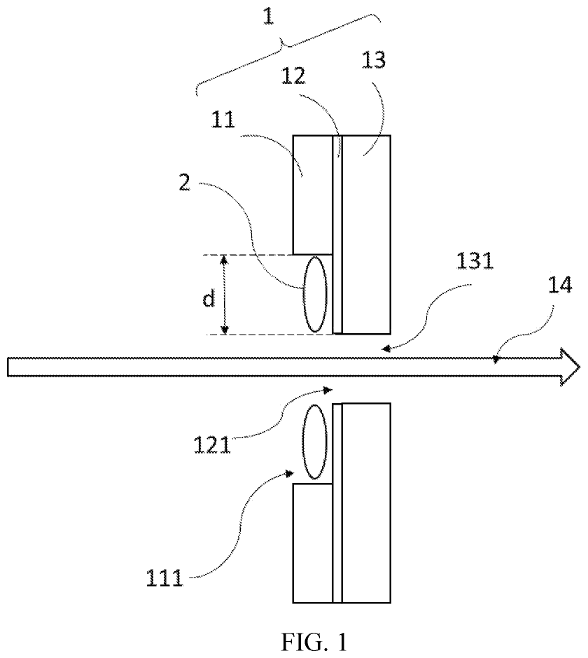

FIG. 1 is a schematic cross-sectional view of an ion source of the first embodiment of the present invention. Please refer to what is shown in FIG. 1, the first embodiment of the present invention provides an ion source, wherein the ion source includes dielectric barrier discharge assemblies 1, the dielectric barrier discharge assembly 1 is composed of a first electrode plate 11, a dielectric spacer plate 12 and a second electrode plate 13 which are in close proximity in parallel in sequence, and a first through hole 111 penetrating through the first electrode plate 11, a second through hole 121 penetrating through the dielectric spacer plate 12 and a third through hole 131 penetrating through the second electrode plate 13 are disposed corresponding to each other to form a gas passageway 14 for gas to be ionized (a region indicated by the arrow in FIG. 1, the direction of the arrow being the flow direction of the gas to be ionized).

In the embodiment of the present invention, the first electrode plate 11 is connected to an output terminal (not shown in FIG. 1) of an AC power supply and the second electrode plate 13 is grounded; or, the first electrode plate 11 is grounded and the second electrode plate 13 is connected to an output terminal of an AC power supply. By applying an alternating voltage to the first electrode plate 11 and the second electrode plate 13, a dielectric barrier discharge region 2 formed by mutually staggering the first electrode plate 11 and the second electrode plate 13 due to an inner diameter difference will generate a dielectric barrier discharge phenomenon, the gas to be ionized is ionized when passing through the dielectric barrier discharge region 2 (a region indicated by an oval in FIG. 1), and an ionized sample enters through a sample entering port of detection equipment of a mass spectrometer for further detection.

Further, the gas to be ionized is gaseous samples, gasified samples or carrier gas. The ion source may be configured such that the gaseous sample or the gasified sample passes through the dielectric barrier discharge assembly 1 directly along the gas passageway 14, and the dielectric barrier discharge assembly 1, to which the alternating voltage is applied, may ionize the gaseous sample or the gasified sample and transport the same to subsequent equipment, such as the detection equipment of the mass spectrometer. In some embodiments, the ion source may also be configured to make nitrogen or other carrier gas of inert gas pass through the dielectric barrier discharge assembly 1 along the gas passageway 14. An ion torch formed by ionization of the carrier gas is coupled to a gaseous sample flow path or a gasified sample flow path and then exchanges ions with the gaseous sample or the gasified sample to ionize the sample. The ionized sample is then transported to the subsequent equipment, such as the detection equipment of the mass spectrometer, for ion analysis.

An alternating current used in the embodiment of the present invention has a voltage ranging from 1000 V to 10000 V and a frequency ranging from 40 KHZ to 1 MHZ, preferably from 40 KHZ to 100 KHZ. In addition to directly ionizing the gaseous sample or the gasified sample, the high voltage power supply may also ionize the carrier gas to form a plasma wake flame to ionize the sample, the carrier gas being one or a combination of helium, argon, neon, and nitrogen.

Specifically, the dielectric barrier discharge region 2 may be located on the inner side (i.e. the right side in FIGS. 1 to 5) and the outer side (i.e. the left side in FIGS. 1 to 5) of the dielectric spacer plate 12 or distributed on both sides of the dielectric spacer plate 12 at the same time.

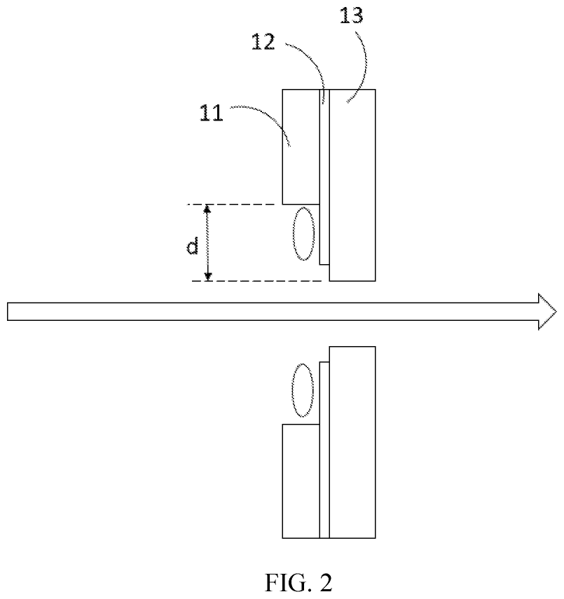

In the embodiment shown in FIG. 1 and FIG. 2, the radius of the first through hole 111 is greater than the radius of the third through hole 131, the radius of the second through hole 121 is greater than or equal to the radius of the third through hole 131, and the dielectric barrier discharge region 2 is located on the outer side of the dielectric spacer plate 12. In FIG. 1, the radius of the second through hole 121 and the radius of the third through hole 131 are the same so that a contact area of the gas to be ionized with the dielectric barrier discharge region 2 is greater and the ionization efficiency is higher.

Specifically, as shown in FIG. 1, in the first embodiment of the present invention, the radius of the first through hole 111 is greater than the radius of the third through hole 131, and the radius of the second through hole 121 is equal to the radius of the third through hole 131. The radius of the first through hole 111 differs from the radius of the third through hole 131 by 5 mm or less. When a radius difference d of the first through hole 111 and the third through hole 131 is within 5 mm, the requirement for the size of the dielectric barrier discharge region 2 generated by discharge of the first electrode plate 11 and the second electrode plate 13 can be satisfied, an ion source structure can also be miniaturized, the production cost is saved, and the space utilization rate of the ion source structure is improved.

In the second embodiment as shown in FIG. 2, the radius of the first through hole 111 is greater than the radius of the second through hole 121, and the radius of the first through hole 111 is greater than the radius of the third through hole 131. Because the radius of the first through hole 111 is greater than the radius of the second through hole 121, the dielectric spacer plate 12 can effectively form a dielectric barrier for the first electrode plate 11 and the second electrode plate 13 to prevent that electric arcs cross the dielectric spacer plate 12 and then conduct the first electrode plate 11 and the second electrode plate 13, thus preventing breakdown between the electrode plates. At the same time, as the radius of the first through hole 111 is greater than the radius of the third through hole 131, by using the electrode plates with different apertures, the wider dielectric barrier discharge region 2 can be formed between the electrode plates, and a contact area of the gaseous sample with the dielectric barrier discharge region 2 is greater, which enhances the ionization efficiency.

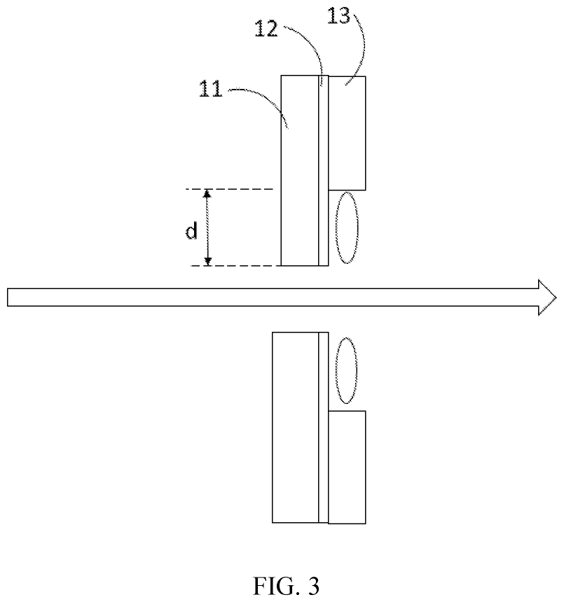

In the third embodiment as shown in FIG. 3, the radius of the first through hole 111 in the center of the first electrode plate 11 is smaller than the radius of the third through hole 131 in the center of the second electrode plate 13, the dielectric barrier discharge region 2 is located on the inner side of the dielectric spacer plate 12, the gas to be ionized mainly makes contact with the plasma wake flame generated by driving of the gas flow, is less affected by the gas flow, has higher stability, and has a smaller degree of ionization, i.e. less fragment ions are generated. In the present embodiment, the radius of the second through hole 121 may be equal to or greater than the radius of the first through hole 111.

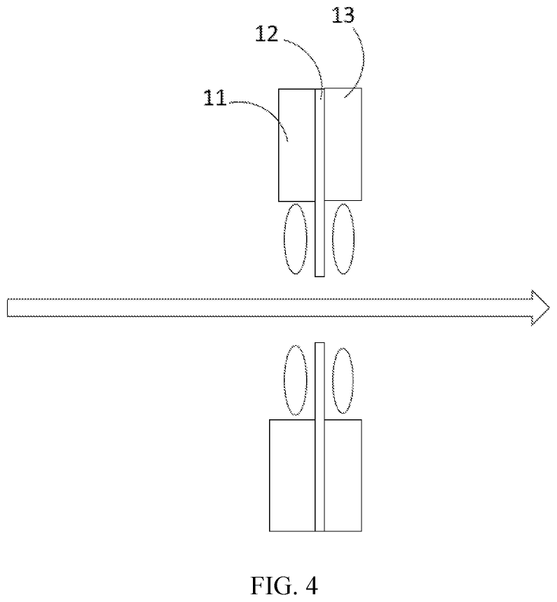

In the fourth embodiment shown in FIG. 4, the radius of the first through hole 111 is equal to the radius of the third through hole 131, and the dielectric barrier discharge region 2 is located on both sides of the dielectric spacer plate 12 in such a manner that the problem of electrical breakdown can be effectively solved since the dielectric spacer plate 12 extends and protrudes between the first electrode plate 11 and the second electrode plate 13. Also, since the radius of the first through hole 111 and radius of the third through hole 131 are equal, electrode plates of the same specification and size can be used for the first electrode plate 11 and the second electrode plate 13, further reducing the manufacturing cost. The structure can also realize stable discharge between the first through hole 111 and the third through hole 131. In other embodiments of the present invention, the radius of the first through hole 111 may be different from the radius of the third through hole 131.

In the embodiment of the present invention, the first electrode plate 11 and the second electrode plate 13 may have an inner diameter difference, and the position of the dielectric barrier discharge region 2 may be defined between the first electrode plate 11 and the second electrode plate 13 having the inner diameter difference by using a simple device structure, which is conductive to ensuring the ionization strength and the ionization stability of the dielectric barrier discharge assembly 1, improving the ionization efficiency. As a modified example, the first electrode plate 11 and the second electrode plate 13 may also be of equal diameter, for example, in the embodiment provided in FIG. 4.

“Inner” and “outer” in the embodiment of the present invention are relative to the detection equipment of the mass spectrometer, specifically, the side of the dielectric spacer plate 12 facing the detection equipment of the mass spectrometer is the inner side and the side of the dielectric spacer plate 12 deviating from the detection equipment of the mass spectrometer is the outer side.

In the embodiment of the present invention, the direction of the gas passageway 14 is from the first electrode plate 11 to the second electrode plate 13; in other embodiments, the direction of the gas passageway 14 may also be from the second electrode plate 13 to the first electrode plate 11. The embodiment of the present invention does not define the direction of the gas passageway 14, and a person skilled in the art would have been able to determine the direction of the gas passageway 14 according to actual situations.

In the embodiment of the present invention, the first through hole 111, the second through hole 121, and the third through hole 131 are disposed corresponding to each other. Further, the first through hole 111, the second through hole 121, and the third through hole 131 are coaxially disposed. The structure of the first through hole 111, the second through hole 121 and the third through hole 131 which are disposed coaxially is more compact, the distribution of the ion torch is more uniform and ionization is more stable, and the gas passageway 14 is formed in a region where the axis direction of the first through hole 111, the second through hole 121 and the third through hole 131 is located, which improves the orderliness of the gas passageway 14 and the dielectric barrier discharge region 2 and the unobstructed performance of the gas passageway 14, so that the gas to be ionized can smoothly enter the gas passageway 14 and the dielectric barrier discharge region 2 to be sufficiently ionized, which improves the ionization efficiency and the ionization effect. In some embodiments, the first through hole 111, the second through hole 121, and the third through hole 131 may also be disposed corresponding to each other in a non-coaxial manner.

In a preferred embodiment of the present invention, the operating pressure of the ion source is an atmospheric pressure, or a low gas pressure environment between 100 Pa and the atmospheric pressure. In the embodiment of the present invention, the operating pressure of the ion source is an atmospheric pressure, or a low pressure environment, a vacuum system of the ion source may use a smaller-volume pump or the vacuum system of the ion source may be omitted, facilitating miniaturization of the ion source.

In a preferred embodiment of the present invention, the dielectric spacer plate 12 is made from ceramic, glass or quartz. The dielectric spacer plate 12 is made from materials such as ceramic, glass or quartz, these materials not only have a good thermal insulation property, but also have a good insulation property, manufacturing and processing are easy, and the price is low. Further, the thickness of the dielectric spacer plate 12 is 0.2-5 mm; further, the thickness of the dielectric spacer plate 12 is 0.25 mm, 0.5 mm, 1 mm and 2 mm; the thickness of the dielectric spacer plate 12 is preferably less than 0.25 mm to ensure that the dielectric spacer plate 12 plays a dielectric barrier role thereof while facilitating miniaturization. The thickness of the dielectric spacer plate 12 is an important parameter in the ion source structure, and this thickness should be matched with the voltage and frequency of the AC power supply, so as to obtain a strong and stable uniform and stable discharge device.

In addition, in the case where the carrier gas is used, the flow rate of the carrier gas will affect the residence time of the gas to be ionized in the dielectric barrier discharge region 2, which further affects the ionization efficiency and stability of the gas to be ionized. It is important to note that the insulating coefficient of the space may be reduced when the flow rate of the carrier gas is too high, which may result in breakdown discharge. Preferably, the flow rate of the carrier gas can be controlled in the range of 1 ml/min to 500 ml/min to balance the above problems.

In a preferred embodiment of the present invention, the first electrode plate 11, the second electrode plate 13 and the dielectric spacer plate 12 are all annular. The annular first electrode plate 11, dielectric spacer plate 12 and second electrode plate 13 are disposed in close proximity in parallel with each other. Because the planar DBD device is formed by combining the tabulate first electrode plate 11, second electrode plate 13 and dielectric spacer plate 12, the first electrode plate, the second electrode plate and the dielectric spacer plate can fit to each other at a high degree just needing that the plate surfaces of the first electrode plate, the second electrode plate and the dielectric spacer plate are substantially flat and smooth, and it is not required to strictly control the arc surface accuracy of the electrodes and the insulating dielectric, so that the requirement for the machining accuracy is lower, and it is more easier to maintain the discharge stability. In addition, by using the central through hole of the DBD device as the gas flow passageway 14, it is possible to directly transport ionized ions to the other side of the DBD device along with gas glow while the gas flow is ionized. The axial direction of the DBD device is the transportation direction of the gas flow. Since the DBD device consists of multiple plate-shaped objects stacked in the axial direction, the thickness in the axial direction is only the sum of the thicknesses of the multiple plate-shaped objects, so the DBD device can be used as an ion source of a mass spectrometer, which can effectively reduce the overall axial length of the mass spectrometer and facilitate the miniaturization of the mass spectrometer.

Further, the surfaces of the annular first electrode plate 11, dielectric spacer plate 12, and second electrode plate 13 are smooth and flat, which is advantageous in preventing partial easy discharge of the electrode plate or easy discharge caused by a processing defect.

In some embodiments, the first electrode plate 11, the second electrode plate 13, and the dielectric spacer plate 12 may also be special-shaped, such as triangular, rectangular, etc.

Further, in a preferred embodiment of the present invention, the radius of the second through hole 121 is 0.5-5 mm. The radius of the second through hole 121 should not be too large or too small; when the radius of the second through hole 121 is less than 0.5 mm, since the gas flow will flow through the second through hole 121 and then reach an ion interface of the detection equipment of the mass spectrometer, if the radius of the second through hole 121 is too small, the gas inlet volume of the subsequent mass spectrometry detection equipment may be limited; when the radius of the second through hole 121 is greater than 5 mm, the gas passageway 14 is too wide, the distance between the dielectric barrier discharge region and the gas passageway in the radial direction is enlarged, resulting in the ionized ions not being able to pass through the DBD device smoothly, which may easily lead to insufficient ionization and low ionization efficiency.

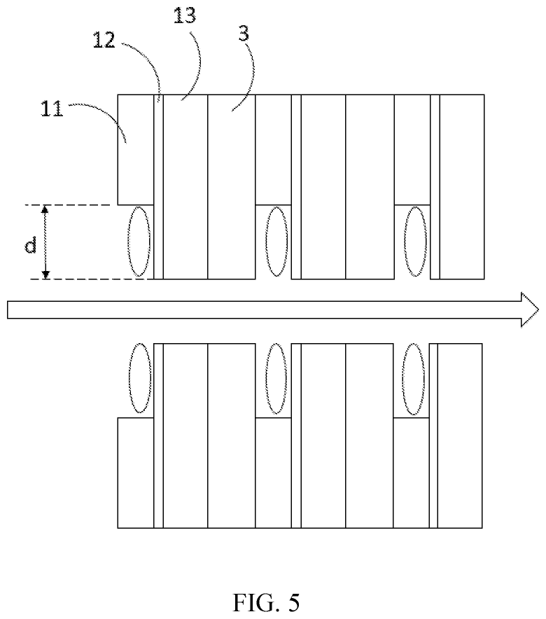

FIG. 5 is a schematic cross-sectional view of an ion source of the fifth embodiment of the present invention. In a preferred embodiment of the present invention, the ion source has a plurality of dielectric barrier discharge assemblies 1, and gas passageways 14 of the plurality of dielectric barrier discharge assemblies 1 are disposed coaxially.

Specifically, each dielectric barrier discharge assembly 1 of the plurality of dielectric barrier discharge assemblies 1 may be dielectric barrier discharge assemblies 1 of the same specification or dielectric barrier discharge assemblies 1 of different specifications. The specification herein refers to the radius of the first through hole 111, the second through hole 121 and the third through hole 131 of each dielectric barrier discharge assembly 1 as well as the material, thickness and other parameters of the first electrode plate 11, the second electrode plate 13 and the dielectric spacer plate 12, and the specification of the plurality of dielectric barrier discharge assemblies 1 is not limited in the present invention.

In addition, with continued reference to FIG. 5, in the fifth embodiment, between two adjacent dielectric barrier discharge assemblies 1, an inter-assembly dielectric spacer plate 3, such as the inter-assembly dielectric spacer plate 3 with a greater thickness or a higher insulating coefficient, with the insulating capacity greater than that of the dielectric spacer plate 12 is further disposed.

Specifically, the inter-assembly dielectric spacer plate 3 is made from insulating dielectric, the inter-assembly dielectric spacer plate 3 is disposed to facilitate blocking the discharge of the adjacent dielectric barrier discharge assemblies 1, so that each dielectric barrier discharge assembly 1 performs discharge independently, which avoids that the discharge of the adjacent dielectric barrier discharge assemblies 1 interacts with each other. The inter-assembly dielectric spacer plate 3 of a greater thickness is advantageous in improving the insulating barrier property, preventing the first electrode plate 11 and the second electrode plate 13 from being broken down.

In some embodiments of the present invention, when the dielectric constant of the inter-assembly dielectric spacer plate 3 is high and the insulating property of the inter-assembly dielectric spacer plate 3 is good, the thickness of the inter-assembly dielectric spacer plate 3 may also be less than the thickness of the dielectric spacer plate 12 to facilitate the development of miniaturization of the ion source structure.

In other embodiments of the present invention, the inter-assembly dielectric spacer plate 3 may also omit the use of the insulating property of air to enable independent discharge between two adjacent dielectric barrier discharge assemblies 1, without affecting each other, so as to improve the uniformity of discharge of each dielectric barrier discharge assembly 1 of the ion source and the uniformity of the ionization effect. The thickness of the inter-assembly dielectric spacer plate 3 and the distance between the adjacent dielectric barrier discharge assemblies 1 are not limited.

In summary, in the embodiments of the present invention, the first electrode plate 11, the dielectric spacer plate 12 and the second electrode plate 13 are all plate-shaped members, so that it is easy for the first electrode plate, the dielectric spacer plate and the second electrode plate to be in close fit in parallel with each other, the structure is simple and assembling is easy, which is advantageous in reducing the partial discharge phenomenon; the small size of the ion source and the small thickness of the structure in front of the interface of the mass spectrometry detection equipment promote the development of miniaturization of the mass spectrometer, and the dielectric spacer plate 12 is only partially exposed in the gas passageway 14, which can reduce the accumulation of charges on the surface of the dielectric spacer plate 12.

The present invention further provides a mass spectrometer, including the ion source in the above embodiment. The mass spectrometer including the above ion source has high ionization efficiency, can be miniaturized, is low in cost, and can operate under an atmospheric pressure or a low gas pressure, and the mass spectrometer adapted to use the ion source is preferably a hand-held mass spectrometer or a tabletop mass spectrometer.

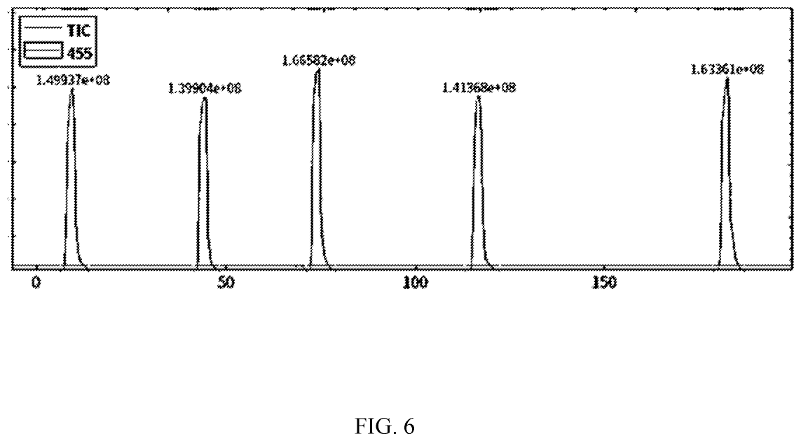

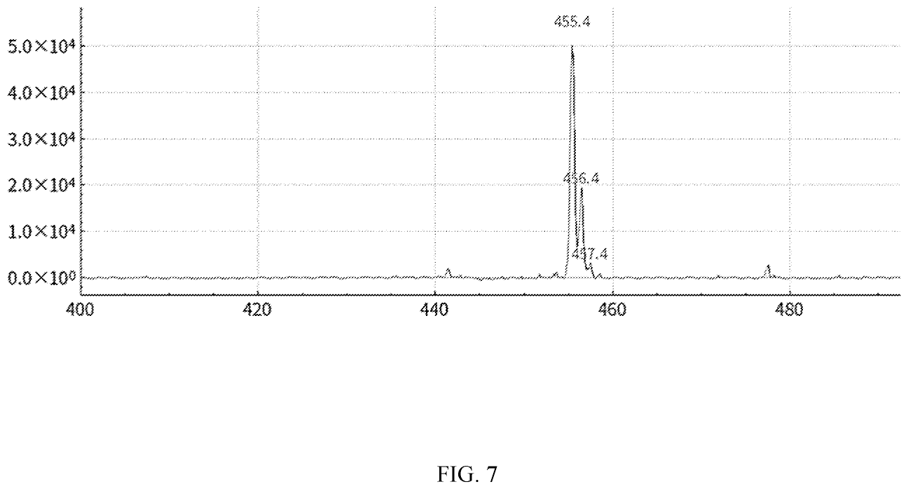

In order to further verify the ionization effect of the dielectric barrier discharge assembly 1 provided in the embodiment of the present invention, a ceramic spacer having a thickness of 0.2 mm and an inner diameter of 2 mm is also selected as the dielectric spacer plate 12 in the present embodiment, and the dielectric spacer plate and the first electrode plate 11 and the second electrode plate 12 having an inner diameter of 3 mm and 2 mm, respectively, are configured according to the method illustrated in FIG. 1 and then assembled by using a support made of a polyetheretherketone material. The DBD ion source is mounted at the sample entering port of the mass spectrometry detection equipment. The voltage of the power supply is 2000 V and the frequency of the power supply is 70 KHZ. Then 1 ng of Verapamil solution is gasified in a method of thermal desorption. Under the action of a negative pressure at the sample entering port of the mass spectrometer detection equipment, the gaseous Verapamil sample flows through the ion source provided in the embodiment of FIG. 1 and then enters the mass spectrometer. Mass spectral signals obtained from repeated tests of fives time are as shown in FIG. 6, the abscissa in FIG. 6 is the sampling time (Time/sec) and the ordinate is an extracted ion current XIC with the mass number of 455 extracted from a total ion current TIC. A mass spectrum view obtained is as shown in FIG. 7, wherein the abscissa in FIG. 7 is the mass number and the ordinate is the signal intensity. It can be seen from FIG. 6 and FIG. 7 that the ion source in the embodiment of the present invention has a higher ionization efficiency and better reproducibility in testing micro samples.

The above description is merely a preferred embodiment of the present invention and is not to be construed as limiting the present invention. Any modifications, equivalent replacements and improvements made within the spirit and principles of the present invention shall fall within the protection scope of the present invention.

1. An ion source, wherein the ion source comprises dielectric barrier discharge assemblies, the dielectric barrier discharge assembly being composed of a first electrode plate, a dielectric spacer plate and a second electrode plate which are in close proximity in parallel in sequence,
a first through hole penetrating through the first electrode plate, a second through hole penetrating through the dielectric spacer plate and a third through hole penetrating through the second electrode plate being disposed corresponding to each other to form a gas passageway for gas to be ionized.

2. The ion source according to claim 1, wherein the radius of the first through hole is greater than the radius of the second through hole, and the radius of the first through hole is greater than the radius of the third through hole.

3. The ion source according to claim 2, wherein the radius of the first through hole differs from the radius of the third through hole by 5 mm or less.

4. The ion source according to claim 1, wherein the first through hole, the second through hole and the third through hole are disposed coaxially, the radius of the first through hole and the radius of the third through hole being the same, both being greater than the radius of the second through hole.

5. The ion source according to claim 1, wherein the direction of the gas passageway is from the first electrode plate to the second electrode plate, or, from the second electrode plate to the first electrode plate.

6. The ion source according to claim 1, wherein, the ion source has the plurality of dielectric barrier discharge assemblies, the gas passageways of the plurality of dielectric barrier discharge assemblies being disposed coaxially.

7. The ion source according to claim 6, wherein, an inter-assembly dielectric spacer plate with the insulating capacity greater than that of the dielectric spacer plate is further disposed between two adjacent dielectric barrier discharge assemblies.

8. The ion source according to claim 1, wherein the first electrode plate, the second electrode plate and the dielectric spacer plate are all annular.

9. The ion source according to claim 1, wherein the dielectric spacer plate is made from ceramic, glass or quartz.

10. The ion source according to claim 1, wherein the operating pressure of the ion source is an atmospheric pressure, or a low gas pressure environment between 100 Pa and the atmospheric pressure.

11. The ion source according to claim 1, wherein
the first electrode plate is connected to an AC power supply and the second electrode plate is grounded; or,
the first electrode plate is grounded and the second electrode plate is connected to an AC power supply.

12. The ion source according to claim 1, wherein the gas to be ionized is gaseous samples, gasified samples or carrier gas.

13. The ion source according to claim 1, wherein the radius of the second through hole is 0.5-5 mm.

14. A mass spectrometer, comprising the ion source according to claim 1.
